(19) United States
(12) Patent Application Publication
(10) Pub. No.: US 2023/0113907 A1
(43) Pub. Date: Apr. 13, 2023

(54) LOAD CELL

(71) Applicant: Northstar Load Cell and Scale LLC, Three Lakes, WI (US)

(72) Inventor: Dan Folmer, Three Lakes, WI (US)

(21) Appl. No.: 17/495,969

(22) Filed: Oct. 7, 2021

(51) Int. Cl. B60D 1/24; B60D 1/06

(52) U.S. Cl. CPC B60D 1/248; B60D 1/06; G01L 5/136

(57) ABSTRACT

A hitch load cell including a ball hitch with a spherical surface and a stem extending from the spherical surface along a longitudinal axis. The hitch load cell further includes a first resistor positioned on a first side of the stem, a second resistor positioned on a second side of the stem, a third resistor positioned on the first side, a fourth resistor positioned on the second side. The first resistor, the second resistor, the third resistor, and the fourth resistor are electrically coupled in a Wheatstone bridge configuration.

### FIELD OF INVENTION

The present invention relates to a load cell and, more particularly, a ball hitch load cell for hauling trailers behind a vehicle.

### BACKGROUND

Vehicle hitches mechanically couple a vehicle (e.g., a truck, car, etc.) to a trailer (e.g., a travel trailer, a flatbed trailer, a livestock trailer, a tank trailer, etc.) such that the trailer is hauled or towed behind the vehicle. A ball hitch or ball mount is a commonly used hitch.

Ball hitches are organized into classes that define their loading capacities as gross trailer weight (GTW) and tongue weight (TW). In the United States, these ratings are covered by engineering standards (i.e., SAE J684-201405 standard). Towing a trailer behind a vehicle that is improperly balanced or exceeds the intended loading is dangerous. In particular, the tongue weight is important for the average user who may be towing a trailer on the road or highway. Too little tongue weight can cause the trailer to sway side-to-side. Too much tongue weight can cause the front of the towing vehicle to rise, rendering the towing vehicle less responsive to steering and braking. These dangerous conditions aren't immediately obvious when the towing vehicle is stationary or moving at low speeds. Rather, the dangerous conditions manifest themselves at normal road operating speeds, which makes detecting the tongue weight beforehand important. However, conventional hitch technology does not provide a convenient mechanism for measuring the tongue weight of a trailer without altering the mechanical strength or integrity of the ball hitch (i.e., in a non-invasive manner).

For example, conventional designs modify the structure of the drawbar or hitch to incorporate a sensor. However, such structural modification risks changing the loading capacity of the ball hitch. In other examples, conventional designs add a separate load sensor that are not integrated or accurate.

### SUMMARY

The Summary is provided to introduce a selection of concepts that are further described below in the Detailed Description. This Summary is not intended to identify key or essential features of the claimed subject matter, nor is it intended to be used as an aid in limiting the scope of the claimed subject matter.

One aspect of the present disclosure provides a hitch load cell including a ball hitch with a spherical surface and a stem extending from the spherical surface along a longitudinal axis. The hitch load cell further includes a first resistor positioned on a first side of the stem, a second resistor positioned on a second side of the stem, a third resistor positioned on the first side, a fourth resistor positioned on the second side. The first resistor, the second resistor, the third resistor, and the fourth resistor are electrically coupled in a Wheatstone bridge configuration.

In some embodiments, the first resistor and the second resistor are positioned approximately 180 degrees apart around the longitudinal axis.

In some embodiments, the hitch load cell further includes an adjustment resistor positioned on the stem.

In some embodiments, the adjustment resistor is positioned approximately 90 degrees apart from first resistor around the longitudinal axis.

In some embodiments, the adjustment resistor is electrically coupled to the first resistor and the second resistor.

In some embodiments, the first resistor and the fourth resistor are oriented to sense compression of the ball hitch.

In some embodiments, the second resistor and the third resistor are oriented to sense Poisson tension of the ball hitch.

In some embodiments, the first resistor is oriented a first direction, and the third resistor is oriented a second direction different than the first direction.

In some embodiments, the first resistor and the third resistor are oriented in a T-Rosette arrangement.

In some embodiments, the first resistor is a strain gauge and the Wheatstone bridge configuration is a quarter Wheatstone bridge.

In some embodiments, the first resistor and the fourth resistor are strain gauges and the Wheatstone bridge configuration is a half Wheatstone bridge.

In some embodiments, the first resistor, the second resistor, the third resistor, and the fourth resistor are strain gauges, and the Wheatstone bridge configuration is a full Wheatstone bridge.

In some embodiments, an output of the Wheatstone bridge configuration changes linearly with respect to a load applied to the ball hitch.

In some embodiments, the hitch load cell includes a display electrically coupled to the Wheatstone bridge configuration and configured to display the load applied to the ball hitch.

In some embodiments, the hitch load cell includes a housing at least partially enclosing the first resistor, the second resistor, the third resistor, the fourth resistor, and the stem.

In some embodiments, the ball hitch further includes a base, wherein the stem is positioned between the base and the spherical surface; and wherein the hitch load cell further includes a solder tab positioned on the base and electrically coupled to the Wheatstone bridge configuration.

Another aspect of the present disclosure provides a load cell including a ball hitch, a first resistor coupled to the ball hitch, a second resistor coupled to the ball hitch, a third resistor coupled to the ball hitch, and a fourth resistor coupled to the ball hitch. The first resistor, the second resistor, the third resistor, and the fourth resistor are electrically coupled in a Wheatstone bridge configuration. The load cell further includes a display electrically coupled to the Wheatstone bridge configuration and configured to display a load applied to the ball hitch.

In some embodiments, the load cell includes an adjustment resistor coupled to the ball hitch and electrically coupled to the Wheatstone bridge configuration.

In some embodiments, the first resistor and the third resistor are oriented orthogonal to each other, and wherein the second resistor and the fourth resistor are oriented orthogonal to each other.

In some embodiments, the first resistor, the second resistor, the third resistor, and the fourth resistor are strain gauges and the Wheatstone bridge configuration is a full Wheatstone bridge.

In some embodiments, a output signal to input signal ratio of the full Wheatstone bridge is within a range of 0.01 millivolts per volt and 0.05 millivolts per volt.

Other aspects of the disclosure will become apparent by consideration of the detailed description and accompanying drawings.

### BRIEF DESCRIPTION OF THE DRAWINGS

The accompanying figures and examples are provided by way of illustration and not by way of limitation. The foregoing aspects and other features of the disclosure are explained in the following description, taken in connection with the accompanying example figures (also “FIG.”) relating to one or more embodiments.

FIG. 1 is a perspective view of a ball hitch load cell.

FIG. 2 is a cross-sectional view of the ball hitch load cell of FIG. 1 coupled to a trailer.

FIG. 3 is a side view of the ball hitch load cell of FIG. 1.

FIG. 4 is a perspective view of a ball hitch load cell including a display.

FIG. 5 is a perspective view of the ball hitch load cell of FIG. 1, with portions removed for clarity.

FIG. 6A is a partial perspective view of the ball hitch load cell of FIG. 1.

FIG. 6B is another partial perspective view of the ball hitch load cell of FIG. 1.

FIG. 7 is an electrical schematic of a Wheatstone bridge configuration.

Before any embodiments are explained in detail, it is to be understood that the invention is not limited in its application to the details of construction and the arrangement of components set forth in the following description or illustrated in the following drawings. The invention is capable of other embodiments and of being practiced or of being carried out in various ways.

### DETAILED DESCRIPTION

Unless otherwise defined, all technical and scientific terms used herein have the same meaning as commonly understood by one of ordinary skill in the art. In case of conflict, the present document, including definitions, will control. Preferred methods and materials are described below, although methods and materials similar or equivalent to those described herein can be used in practice or testing of the present disclosure. All publications, patent applications, patents and other references mentioned herein are incorporated by reference in their entirety. The materials, methods, and examples disclosed herein are illustrative only and not intended to be limiting.

For the purposes of promoting an understanding of the principles of the present disclosure, reference will now be made to preferred embodiments and specific language will be used to describe the same. It will nevertheless be understood that no limitation of the scope of the disclosure is thereby intended, such alteration and further modifications of the disclosure as illustrated herein, being contemplated as would normally occur to one skilled in the art to which the disclosure relates.

Articles “a” and “an” are used herein to refer to one or to more than one (i.e., at least one) of the grammatical object of the article. By way of example, “an element” means at least one element and can include more than one element.

“About” and “approximately” are used to provide flexibility to a numerical range endpoint by providing that a given value may be “slightly above” or “slightly below” the endpoint without affecting the desired result.

The use herein of the terms “including,” “comprising,” or “having,” and variations thereof, is meant to encompass the elements listed thereafter and equivalents thereof as well as additional elements. As used herein, “and/or” refers to and encompasses any and all possible combinations of one or more of the associated listed items, as well as the lack of combinations when interpreted in the alternative (“or”).

Moreover, the present disclosure also contemplates that in some embodiments, any feature or combination of features set forth herein can be excluded or omitted. To illustrate, if the specification states that an apparatus comprises components A, B, and C, it is specifically intended that any of A, B or C, or a combination thereof, can be omitted and disclaimed singularly or in any combination.

Recitation of ranges of values herein are merely intended to serve as a shorthand method of referring individually to each separate value falling within the range, unless otherwise indicated herein, and each separate value is incorporated into the specification as if it were individually recited herein. For example, if a concentration range is stated as 1% to 50%, it is intended that values such as 2% to 40%, 10% to 30%, or 1% to 3%, etc., are expressly enumerated in this specification. These are only examples of what is specifically intended, and all possible combinations of numerical values between and including the lowest value and the highest value enumerated are to be considered to be expressly stated in this disclosure.

As used herein, “stress” is the ratio of the external forces to the cross-sectional area of material. As used herein, “strain” is the ratio of the change in length to the original length. As used herein, “microstrain” is the strain expressed in millionths.

As used herein, “modulus of elasticity” or “Young's modulus” is the measurement of a material's resistance to elastic deformation defined by the slope of a stress-strain curve in the elastic deformation region below the proportional limit. For example, the modulus of elasticity of steel is approximately 30×10⁶ psi.

As used herein, “Poisson ratio” is the deformation of a material in directions perpendicular to the loading direction. For a steel ball hitch the Poisson ratio is approximately 0.3. As used herein, “Poisson tension” is the stress created in a material that is perpendicular to the loading direction.

As used herein, “gauge factor” is a property of a strain gauge defined as the ratio of the relative change in the electrical resistance to the mechanical strain of the material surface. In some embodiments, the gauge factor is approximately 2.12.

As used herein, “Wheatstone bridge configuration” is an electrical circuit used to measure at least one unknown electrical resistor. Wheatstone bridge configuration includes a quarter, half, and full Wheatstone bridge.

Unless otherwise defined, all technical terms used herein have the same meaning as commonly understood by one of ordinary skill in the art to which this disclosure belongs.

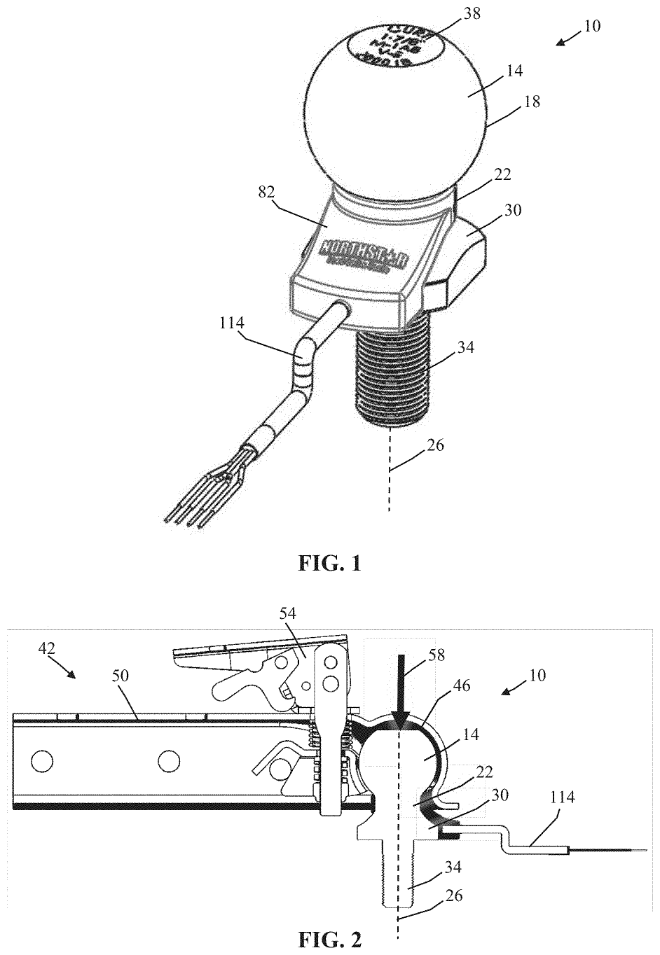

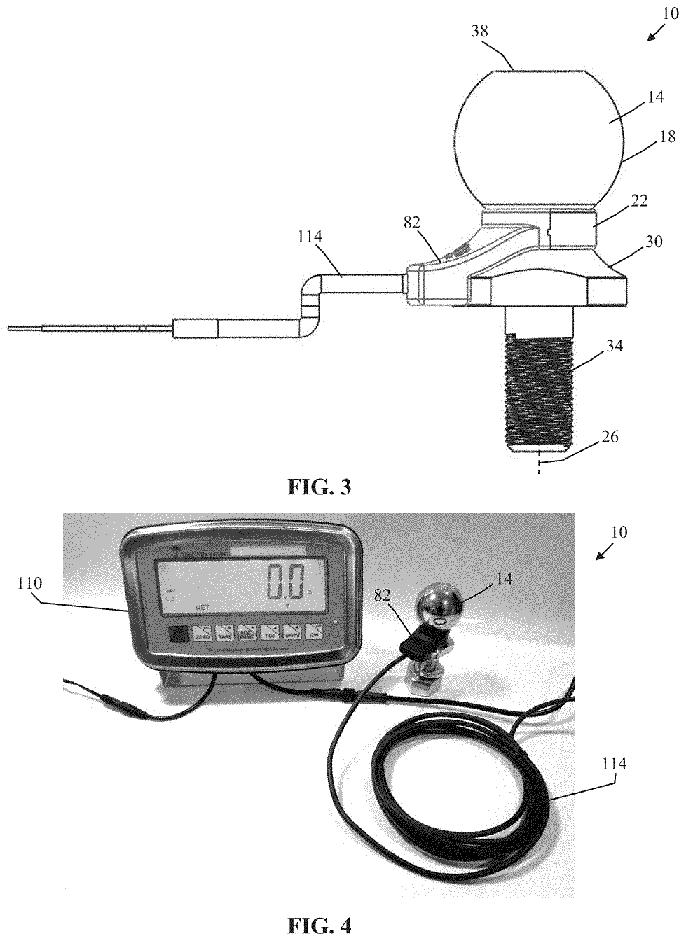

With reference to FIGS. 1 and 3, a hitch load cell 10 is illustrated. In the illustrated embodiment, the hitch load cell 10 is a ball hitch load cell including a ball hitch 14. The ball hitch 14 includes a spherical surface 18 and a stem 22 extending from the spherical surface 18 along an axis 26. The ball hitch 14 also includes a base 30 and the stem 22 is positioned between the base 30 and the spherical surface 18. In the illustrated embodiment, the ball hitch 14 further includes a threaded rod 34 extending from the base 30. The threaded rod 34 is configured to couple the ball hitch 14 to a tongue of a vehicle, for example. In the illustrated embodiment, the base 30 is positioned between the stem 22 and the threaded rod 34. In some embodiments, the ball hitch 14 includes a planar top surface 38. In other embodiments, the ball hitch includes variations suitable geometry.

With reference to FIG. 2, the ball hitch 14 is coupled to a trailer 42. In particular, the spherical surface 18 is received within a cavity 46 formed in a tongue 50 (e.g., towbar) of the trailer 42. In the illustrated embodiment, the ball hitch 14 is releasably secured within the cavity 46 by a latch 54. In the illustrated embodiment, the hitch load cell 10 is removably mechanically coupled to the trailer 42 such that the hitch load cell 10 is configured to sense and/or measure a load 58 at the ball hitch 14.

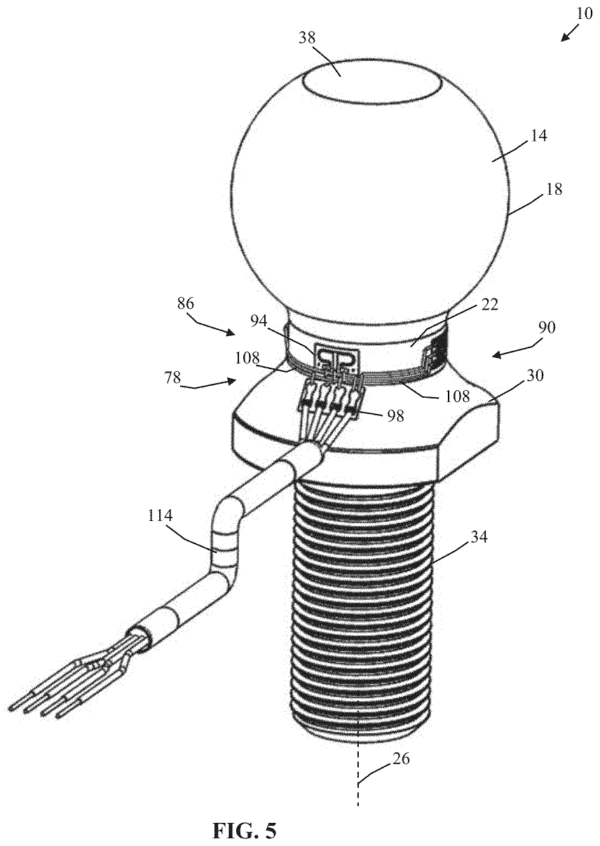

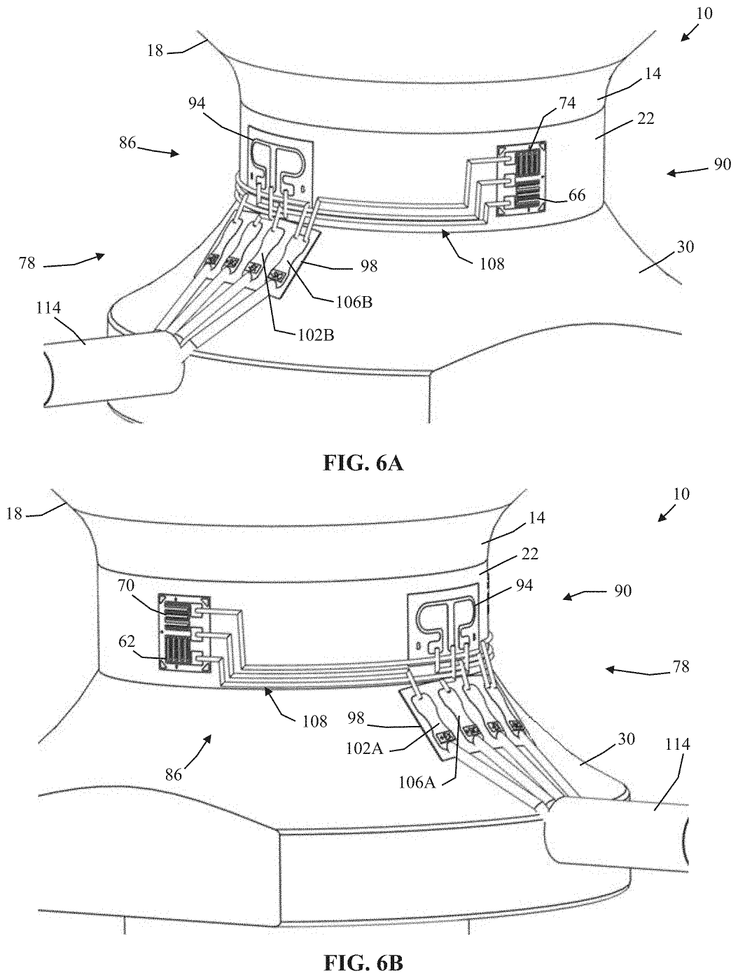

With reference to FIGS. 5, 6A, and 6B, the hitch load cell 10 includes a first resistor 62, a second resistor 66, a third resistor 70, and a fourth resistor 74 electrically coupled in a Wheatstone bridge configuration 78. As referred to herein, the term “Wheatstone bridge configuration” includes, but is not limited to, a quarter Wheatstone bridge, a half Wheatstone bridge, and a full Wheatstone bridge. As referred to herein, a resistor includes, but is not limited to, a fixed-resistance resistor and a strain gauge or variable-resistance resistor. In some embodiments, the hitch load cell 10 includes a housing 82 (FIGS. 1-4) at least partially enclosing the first resistor 62, the second resistor 66, the third resistor 70, the fourth resistor 74, and the stem 22. In the illustrated embodiment, the housing 82 wraps around at least 180 degrees of the stem 22. In other embodiments, the housing 82 wraps entirely around (i.e., 360 degrees around) the stem 22.

With continued reference to FIG. 6B, the first resistor 62 and the third resistor 70 are positioned on a first side 86 of the stem 22. With reference to FIG. 6A, the second resistor 66 and the fourth resistor 74 are positioned on a second side 90 of the stem 22. In the illustrated embodiment, the first side 86 is opposite the second side 90. The first resistor 62 and the second resistor 66 are positioned approximately 180 degrees apart around the axis 26. Likewise, the third resistor 70 and the fourth resistor 74 are positioned approximately 180 degrees apart around the axis 26. Positioning portions of the Wheatstone bridge configuration 78 on opposite sides 86, 90 of the stem 22 (i.e., 180 degrees opposite each other) advantageously cancels out any bending load that might be placed on the ball hitch 14 so that only the compressive load is being sensed. In effect, if a bending load is applied to the ball hitch then the tension stress experienced by one strain gauge corresponds to an equal-but-opposite compression stress being experienced by the strain gauge directly opposite the first, and electrically they cancel each other out in the Wheatstone bridge.

In the illustrated embodiment, the resistors 62, 66, 70, 74 are mounted to the stem 22 with an adhesive (e.g., a cold-curing adhesive, a hot-curing adhesive, etc.). Advantageously, the resistors 62, 66, 70, 74 are coupled to the ball hitch 14 without altering the mechanical structure of the ball hitch 14 itself, which leaves the structural integrity and strength of the ball hitch 14 intact. In other words, the hitch load cell 10 advantageously mechanically couples the Wheatstone bridge configuration 78 to the ball hitch 14 without altering the original mechanical properties of the ball hitch 14. For example, no machining to the ball hitch 14 is required nor is any modifications to any the of the mechanical interfaces of the ball hitch (e.g., threaded rod 34, the spherical surface 18). Ball hitches are manufactured for given loading conditions, and it is important that any load cell maintain the structural integrity of the ball hitch. As such, conventional load cell designs that modify components risk weakening the load capacity of the same.

With continued reference to FIGS. 6A and 6B, the first resistor 62 and the fourth resistor 74 are oriented to sense compression of the ball hitch 14. The second resistor 66 and the third resistor 70 are oriented to sense Poisson tension of the ball hitch 14. In other words, the first resistor 62 is oriented a first direction (e.g., parallel to the axis 26) and the third resistor 70 is oriented a second direction different than the first direction (e.g., perpendicular to the axis 26). In the illustrated embodiment, the first resistor 62 and the third resistor 70 are oriented in a T-Rosette arrangement (i.e., oriented approximately 90 degrees with respect to each other). Likewise, the second resistor 66 and the fourth resistor 74 are oriented approximately perpendicular to each other. In other words, in the illustrated embodiment, the first resistor 62 and the third resistor 70 are oriented orthogonal to each other, and the second resistor 66 and the fourth resistor 74 are oriented orthogonal to each other.

In some embodiments, the first resistor 62 is a strain gauge and the second, third, and fourth resistors 66, 70, and 74 are fixed resistance resistors, such that the Wheatstone bridge configuration is a quarter Wheatstone bridge. In some embodiments, the first resistor 62 and the fourth resistor 74 are strain gauges and the second and third resistors 66, 70 are fixed resistance resistors, such that the Wheatstone bridge configuration is a half Wheatstone bridge. In some embodiments, the first resistor 62, the second resistor 66, the third resistor 70, and the fourth resistor 74 are strain gauges, such that the Wheatstone bridge configuration is a full Wheatstone bridge. In some embodiments, the strain gauges are model no. EA-06-062TZ-350/E available from Vishay Micro-measurements.

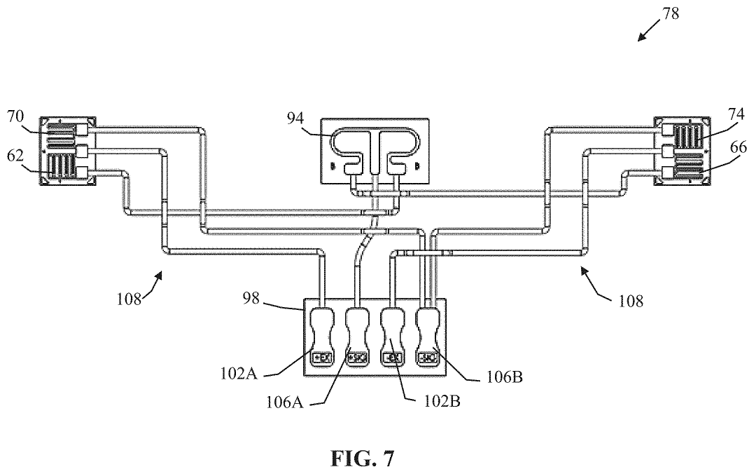

With reference to FIG. 5, in some embodiments, the hitch load cell 10 includes an adjustment resistor 94 positioned on the stem 22. The adjustment resistor 94 is coupled to the ball hitch 14 and electrically coupled to the Wheatstone bridge configuration 78. In the illustrated embodiment, the adjustment resistor 94 is positioned approximately 90 degrees apart from the first resistor 62 and the second resistor 66 around the axis 26. In other words, the adjustment resistor 94 in the illustrated embodiment is positioned approximately halfway between the first resistor 62 and the second resistor 66. In some embodiments, the adjustment resistor 94 is an “erasable” or abradable resistor with an adjustable resistance valve. In the illustrated embodiment, the adjustment resistor 94 is electrically coupled to the first resistor 62 and the second resistor 66 (FIG. 7). In some embodiments, the adjustment resistor 94 is model no. N2A-06-H21-00025 available from Vishay Micro-measurements. As described in further detail herein, the adjustment resistor 94 is utilized to zero-out or calibrate the hitch load cell 10.

With reference to FIGS. 5, 6A, and 6B, the hitch load cell 10 includes a solder tab 98 positioned on the base 30 and electrically coupled to the Wheatstone bridge configuration 78. The solder tab 98 of the illustrated embodiment includes four electrical connections: two connections 102A, 102B for an input signal (e.g., input voltage) and two connections 106A, 106B for an output signal (e.g., an output voltage). In some embodiments, the input signal is a fixed voltage supply of approximately five volts. In some embodiments, the solder tab 98 is model no. CPF-75C available from Vishay Micro-measurements.

With reference to FIG. 7, the Wheatstone bridge configuration 78 is shown electrically coupled to the adjustment resistor 94 and the solder tab 98 with wire 108 (e.g., 30 AWG enamel coated magnet wire). In particular, the connection 102A for the input signal is electrically coupled to the first resistor 62 and the third resistor 70. Likewise, the connection 102B for the input signal is electrically coupled to the second resistor 66 and the fourth resistor 74. The connection 106A for the output signal is electrically coupled to the adjustment resistor 94. The connection 106B for the output signal is electrically coupled to the third resistor 70 and the fourth resistor 74. In the illustrated embodiment, the wire 108 wraps at least partially around the stem 22 of the ball hitch 14.

In the illustrated embodiment, the output signal of the Wheatstone bridge configuration 78 changes linearly with respect to a load applied to the ball hitch 14. Advantageously, the linear output relationship improves the accuracy of the measurement over the operating range. Also, the linear output from the load cell 10 also advantageously enables the use of a simple analog circuit instead of a more complicated digital device for a non-linear output. This allows the electronic display to be a more economical and consumer-friendly instrument. In some embodiments, the Wheatstone bridge configuration 78 (e.g., the full Wheatstone bridge) includes an output-signal-to-input-signal ratio within a range of approximately 0.01 millivolts per volt and approximately 0.05 millivolts per volt. For example, the output ratio for a full Wheatstone bridge (i.e., two axial compression strain gauges and two transverse tension strain gauges) is determined by EQN. 1.

$$\frac{mv}{V} = \frac{\begin{matrix}( gauge factor ) \times ( microstrain ) \times \\ ( 1 + Poisson ratio ) \times ( 0.001 )\end{matrix}}{\begin{matrix}2 + ( gauge factor ) \times \\ ( microstrain ) \times ( 1 - Poisson ratio ) \times ( 0.000001 )\end{matrix}} \qquad ( 1 )$$

Likewise, the output ratio for a half Wheatstone bridge (i.e., two axial compression strain gauges and two fixed resistors) is determined by EQN. 2.

$$\frac{m ν}{V} = \frac{( gauge factor ) \times ( microstrain ) \times ( 0.001 )}{2 + ( gauge factor ) \times ( microstrain ) \times ( 0.000001 )} \qquad ( 2 )$$

Likewise, the output ratio for a quarter Wheatstone bridge (i.e., one axial compression strain gauge and three fixed resistors) is determined by EQN. 3.

$$\frac{mv}{V} = \frac{( gauge factor ) \times ( microstrain ) \times ( 0.001 )}{4 + 2 \times ( gauge factor ) \times ( microstrain ) \times ( 0.000001 )} \qquad ( 3 )$$

In some embodiments, a microstrain is strain expressed in millionths and is determined with EQN 4.

$$microstrain = \frac{( stress ) \times 1 {0}^{6}}{( Young ' s modulus )} = \frac{\frac{( applied force ) \times 1 {0}^{6}}{( cross sectinal area at strain gage centerline )}}{Young ' s modulus} \qquad ( 4 )$$

With reference to FIG. 4, in some embodiments the load cell 10 includes a display 110 electronically coupled to the ball hitch 14. As explained in further detail herein, the display 110 is electrically coupled to the Wheatstone bridge configuration 78 and the display 110 is configured to display the load applied to the ball hitch 14. In the illustrated embodiment, a cable 114 (e.g., a four-conductor cable) extends from the solder tab 98 to the display 110.

In operation, the hitch load cell 10 is utilized to directly and conveniently measure the tongue weight of a trailer by the use of a ball hitch 14 with a Wheatstone bridge configuration 78. The hitch load cell 10 is configured to produce an electrical signal output (i.e., at connectors 106A, 106B) that is directly proportional to the weight applied to the ball hitch 14. As such, the hitch load cell 10 is a compression load cell sensor that allows a user to verify the trailer is applying the proper tongue weight. Advantageously, the hitch load cell 10 is an integrated ball hitch sensor with a linear output that does not compromise the mechanical integrity of the ball hitch. In addition, the hitch load cell 10 is easily removed from a vehicle and replaced or substituted for an existing (non-load cell) ball hitch when a user decides not to use the load cell 10.

To illustrate operation, when a solid material such as steel is compressed with a load along a center axis, the length is physically altered to be shorter than an original unloaded length. In addition, the material will also tend to spread out in the lateral (or transverse) directions perpendicular to the center axis, which is called the Poisson effect. If the load creates a stress/strain relationship that is less than a proportional limit, the material will return to its original shape when the load is removed.

Changes in length and lateral spread of material is measured with the use of strain gauges. As described herein, the strain gauges are resistive sensors that are bonded to the surface of the ball hitch that compress and stretch along with the material beneath them. The resistance of the strain gauges changes in proportion with the change in material length. By connecting the strain gauges in a Wheatstone bridge configuration, changes in resistance produce an electrical signal corresponding to the weight applied to the ball hitch.

One skilled in the art will readily appreciate that the present disclosure is well adapted to carry out the objects and obtain the ends and advantages mentioned, as well as those inherent herein. The present disclosure described herein are exemplary embodiments and are not intended as limitations on the scope of the present disclosure. Changes therein and other uses will occur to those skilled in the art which are encompassed within the spirit of the present disclosure as defined by the scope of the claims.

No admission is made that any reference, including any non-patent or patent document cited in this specification, constitutes prior art. In particular, it will be understood that, unless otherwise stated, reference to any document herein does not constitute an admission that any of these documents forms part of the common general knowledge in the art in the United States or in any other country. Any discussion of the references states what their authors assert, and the applicant reserves the right to challenge the accuracy and pertinence of any of the documents cited herein. All references cited herein are fully incorporated by reference, unless explicitly indicated otherwise. The present disclosure shall control in the event there are any disparities between any definitions and/or description found in the cited references.

Various features and advantages are set forth in the following claims.

What is claimed is:

1. A hitch load cell comprising:
a ball hitch including a spherical surface and a stem extending from the spherical surface along a longitudinal axis;
a first resistor positioned on a first side of the stem;
a second resistor positioned on a second side of the stem;
a third resistor positioned on the first side; and
a fourth resistor positioned on the second side;
wherein the first resistor, the second resistor, the third resistor, and the fourth resistor are electrically coupled in a Wheatstone bridge configuration.

2. The hitch load cell of claim 1, wherein the first resistor and the second resistor are positioned approximately 180 degrees apart around the longitudinal axis.

3. The hitch load cell of claim 2, further including an adjustment resistor positioned on the stem.

4. The hitch load cell of claim 3, wherein the adjustment resistor is positioned approximately 90 degrees apart from first resistor around the longitudinal axis.

5. The hitch load cell of claim 3, wherein the adjustment resistor is electrically coupled to the first resistor and the second resistor.

6. The hitch load cell of claim 1, wherein the first resistor and the fourth resistor are oriented to sense compression of the ball hitch.

7. The hitch load cell of claim 6, wherein the second resistor and the third resistor are oriented to sense Poisson tension of the ball hitch.

8. The hitch load cell of claim 1, wherein the first resistor is oriented a first direction, and the third resistor is oriented a second direction different than the first direction.

9. The hitch load cell of claim 8, wherein the first resistor and the third resistor are oriented in a T-Rosette arrangement.

10. The hitch load cell of claim 1, wherein the first resistor is a strain gauge and the Wheatstone bridge configuration is a quarter Wheatstone bridge.

11. The hitch load cell of claim 1, wherein the first resistor and the fourth resistor are strain gauges and the Wheatstone bridge configuration is a half Wheatstone bridge.

12. The hitch load cell of claim 1, wherein the first resistor, the second resistor, the third resistor, and the fourth resistor are strain gauges and the Wheatstone bridge configuration is a full Wheatstone bridge.

13. The hitch load cell of claim 1, wherein an output of the Wheatstone bridge configuration changes linearly with respect to a load applied to the ball hitch.

14. The hitch load cell of claim 13, further including a display electrically coupled to the Wheatstone bridge configuration and configured to display the load applied to the ball hitch.

15. The hitch load cell of claim 1, further including a housing at least partially enclosing the first resistor, the second resistor, the third resistor, the fourth resistor, and the stem; and wherein the ball hitch further includes a base, wherein the stem is positioned between the base and the spherical surface; and wherein the hitch load cell further includes a solder tab positioned on the base and electrically coupled to the Wheatstone bridge configuration.

16. A load cell comprising:
a ball hitch;
a first resistor coupled to the ball hitch;
a second resistor coupled to the ball hitch;
a third resistor coupled to the ball hitch;
a fourth resistor coupled to the ball hitch; wherein the first resistor, the second resistor, the third resistor, and the fourth resistor are electrically coupled in a Wheatstone bridge configuration; and
a display electrically coupled to the Wheatstone bridge configuration and configured to display a load applied to the ball hitch.

17. The load cell of claim 16, further including an adjustment resistor coupled to the ball hitch and electrically coupled to the Wheatstone bridge configuration.

18. The load cell of claim 17, wherein the first resistor and the third resistor are oriented orthogonal to each other, and wherein the second resistor and the fourth resistor are oriented orthogonal to each other.

19. The load cell of claim 18, wherein the first resistor, the second resistor, the third resistor, and the fourth resistor are strain gauges and the Wheatstone bridge configuration is a full Wheatstone bridge.

20. The load cell of claim 19, wherein an output signal to input signal ratio of the full Wheatstone bridge is within a range of 0.01 millivolts per volt and 0.05 millivolts per volt.
